(19) United States
(12) Patent Application Publication
(10) Pub. No.: US 2020/0311234 A1
(43) Pub. Date: Oct. 1, 2020

(54) ELECTRONIC DEVICE SECURITY

(71) Applicant: LENOVO (Singapore) PTE. LTD., New Teck Park (SG)

(72) Inventors: John Weldon Nicholson, Cary, NC (US); Howard Locker, Cary, NC (US); Daryl Cromer, Raleigh, NC (US)

(21) Appl. No.: 16/367,167

(22) Filed: Mar. 27, 2019

(51) Int. Cl. G06F 21/32; G06K 9/00

(52) U.S. Cl. CPC G06F 21/32; G06K 9/00067; G06F 3/0488; G06F 2221/2117; G06F 2221/2139

(57) ABSTRACT

For unobtrusive electronic device security, methods, apparatus, and systems are disclosed. One apparatus includes a touch surface, a processor and a memory that stores code executable by the processor. The processor captures a fingerprint of a user touching the touch surface. The processor compares the captured fingerprint to an authorized fingerprint and initiates a security response in response to the captured fingerprint not matching the authorized fingerprint.

### FIELD

The subject matter disclosed herein relates to electronic devices and more particularly relates to unobtrusive electronic device security and/or user identification.

### BACKGROUND

Current solutions for providing a high level of authentication for applications that are important to the user, such as mobile banking applications, mobile payment applications, password management applications, have a negative impact on user experience as they require extra steps, such as password entry.

### BRIEF SUMMARY

An apparatus for unobtrusive electronic device security is disclosed. A method and computer program product also perform the functions of the apparatus.

One apparatus for unobtrusive electronic device security includes a touch surface, a processor and a memory that stores code executable by the processor. The processor captures a fingerprint of a user touching the touch surface. The processor compares the captured fingerprint to an authorized fingerprint and initiates a security response in response to the captured fingerprint not matching the authorized fingerprint.

One method for unobtrusive electronic device security includes capturing a fingerprint of a user touching a touch surface of an electronic device. The method also includes comparing, by use of a processor, the captured fingerprint to an authorized fingerprint and initiating a security response in response to the captured fingerprint not matching the authorized fingerprint.

One program product for unobtrusive electronic device security includes a computer readable storage medium that stores code executable by a processor, the executable code comprising code to capture a fingerprint of a user touching the touchscreen and to compare the captured fingerprint to an authorized fingerprint. The program product further contains code to initiate a security response in response to the captured fingerprint not matching the authorized fingerprint, wherein the security response is at least one of: closing an open application, preventing interaction with the application, preventing launch of an unopened application, and locking the electronic device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for unobtrusive electronic device security;

FIG. 2A is a diagram illustrating one embodiment of an apparatus for unobtrusive electronic device security;

FIG. 2B is a diagram illustrating another embodiment of an apparatus for unobtrusive electronic device security;

FIG. 3 is a schematic block diagram illustrating one embodiment of an apparatus for unobtrusive electronic device security;

FIG. 4 is a schematic block diagram illustrating one embodiment of an authentication controller for presenting data acquired from a first user interface while the user is looking at a second user interface;

FIG. 5 is a block diagram illustrating one embodiment of a security policy used for unobtrusive electronic device security;

FIG. 6A is a diagram illustrating a first scenario of unobtrusive electronic device security at a first moment;

FIG. 6B is a diagram illustrating a first scenario of unobtrusive electronic device security at a second moment;

FIG. 6C is a diagram illustrating fingerprint verification in the first scenario of unobtrusive electronic device security;

FIG. 6D is a diagram illustrating implementation of a security measure in the first scenario of unobtrusive electronic device security;

FIG. 7A is a diagram illustrating a second scenario of unobtrusive electronic device security at a first moment;

FIG. 7B is a diagram illustrating the second scenario of unobtrusive electronic device security at a second moment;

FIG. 8 is a flowchart diagram illustrating one embodiment of a method for unobtrusive electronic device security; and

FIG. 9 is a flowchart diagram illustrating another embodiment of a method for unobtrusive electronic device security.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, embodiments may take the form of a program product embodied in one or more computer readable storage devices storing machine readable code, computer readable code, and/or program code, referred hereafter as code. The storage devices are tangible, non-transitory, and/or non-transmission. The storage devices do not embody signals. In a certain embodiment, the storage devices may employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

For unobtrusive electronic device security, methods, systems, and apparatuses are disclosed herein. Here, unobtrusive fingerprint authentication is used to improve the security and convenience of the electronic device. Currently fingerprint sensors are dedicated physical sensors located in a fixed position on the device. Generally, these fingered sensors are located either below the screen or on the backside of the device. Because of the fixed location it takes additional user actions to perform fingerprint check (e.g., the user must stop using the application and place her finger on the fingerprint reader, then after confirmation she can go back to using the application).

New technologies are coming that allow a mobile device or phone to detect and securely recognize a fingerprint anywhere on the display surface. In other words, it is possible to detect and recognize a user's fingerprint every time a user touches the screen. The disclosed embodiments leverage these new technologies to improve security without impacting the user experience.

Even though it may still take a small amount of time and power to do a fingerprint check, the inventors recognize that this is approaching a time duration that is so small as to be unnoticeable to users, particularly when tied to launching/loading an application, accessing a remote database, and other actions that also introduce a small delay in the user experience.

The electronic device may implement various policies depending on the application. A default operation is to perform a fingerprint check on every touch opening an application (e.g., from the app drawer or home screen). If the fingerprint check fails, the electronic device may go into lock mode, as this failure indicates that someone besides the authorized user is using the phone.

For applications requiring high levels of security, such as banking applications, mobile payment applications, password management applications, the security policy may increase the frequency of fingerprint verification. For example, the security policy may check the fingerprint with every touch action within the application. As another example, the security policy may check the fingerprint at a certain interval, such as every 5 second, 15 seconds, 30, seconds, 60 seconds, etc.

The fingerprint checks are performed in the background and, as mentioned above, are transparent to the end user. Thus, improved security through more frequent fingerprint verification will have zero impact on the user experience, as the user is behaving the same as today, e.g., touching various spots on a touchscreen to launch applications and/or interact within the applications.

Additionally, upon launching an application after successful fingerprint verification, the device may perform account switching to load an account belonging to the authorized user. Alternatively, or additionally, the device may load settings and/or user preferences indicated in a user profile belonging to the authorized user.

Disclosed herein is an apparatus for unobtrusive electronic device security. In various embodiments, the apparatus includes a touch surface, a processor, and a memory that stores code executable by the processor. The processor captures a fingerprint of a user touching the touch surface. The processor compares the captured fingerprint to an authorized fingerprint. In response to the captured fingerprint not matching the authorized fingerprint, the processor initiates a security response.

In various embodiments, initiating the security response includes the processor performing at least one of: closing an open application, preventing interaction with the application, preventing launch of an unopened application, and locking the apparatus. In various embodiments, the touch surface comprises one or more of: a touchscreen, a touch panel, a touch-sensitive input device, and a button, wherein the user touches the surface while interacting with the apparatus.

In some embodiments, the user touches the touch surface (e.g., touchscreen) at a location for opening an application. In such embodiments, the processor opens the application in response to the captured fingerprint matching the authorized fingerprint. In certain embodiments, the processor prevents launch of the application in response to the captured fingerprint not matching the authorized fingerprint. Optionally, the processor may also lock the apparatus. In one embodiment, the touch surface is capable of capturing a fingerprint. In other embodiments, a fingerprint sensor is co-located with the touch surface.

In certain embodiments, the authorized fingerprint is associated with a user. In such embodiments, opening the application in response to the captured fingerprint matching the authorized fingerprint includes accessing, via the application, one or more of: a user account associated with the authorized fingerprint and preferences associated with the authorized fingerprint. For example, opening an email client in response to the captured fingerprint matching the authorized fingerprint may include accessing the email account associated with the authorized fingerprint. In certain embodiments, determining whether the application is a restricted application includes comparing an application identifier to a security policy.

In certain embodiments, the processor determines whether the opened application is a restricted application. In such embodiments, the processor verifies one or more additional fingerprint captures in response to the application being a restricted application and initiates the security response in response to the one or more additional fingerprint captures not matching the authorized fingerprint. For example, the processor may lock the electronic device in response to the one or more additional fingerprint captures not matching the authorized fingerprint.

In one embodiment, verifying one or more additional fingerprint captures includes verifying a fingerprint for each touch of the touchscreen while the restricted application is open. In another embodiment, verifying one or more additional fingerprint captures includes verifying an additional fingerprint at a certain interval while the restricted application is open.

In some embodiments, the processor accesses a security policy, wherein comparing the captured fingerprint to the authorized fingerprint occurs in response to a trigger stored in the policy. In some embodiments, the processor stores the authorized fingerprint in a user profile. In some embodiments, the processor registers the authorized fingerprint with one or more applications.

Disclosed herein is a method for unobtrusive electronic device security. In various embodiments, the method includes capturing a fingerprint of a user touching the touch surface and comparing, by use of a processor, the captured fingerprint to an authorized fingerprint. In response to the captured fingerprint not matching the authorized fingerprint, the method includes initiating a security response.

In various embodiments, initiating the security response includes at least one of: closing an open application, preventing interaction with the application, preventing launch of an unopened application, and locking the electronic device. In various embodiments, the touch surface comprises one or more of: a touchscreen, a touch panel, a touch-sensitive input device, and a button, wherein the user touches the surface while interacting with the electronic device.

In some embodiments, the user touches the touch surface (e.g., touchscreen) at a location for opening an application. In such embodiments, the method includes opening the application in response to the captured fingerprint matching the authorized fingerprint. In certain embodiments, the method includes preventing launch of the application in response to the captured fingerprint not matching the authorized fingerprint. Optionally, the security measure may also include locking the electronic device.

In certain embodiments, the authorized fingerprint is associated with a user. In such embodiments, opening the application in response to the captured fingerprint matching the authorized fingerprint includes accessing, via the application, one or more of: a user account associated with the authorized fingerprint and preferences associated with the authorized fingerprint. For example, opening a calendar application in response to the captured fingerprint matching the authorized fingerprint may include accessing the calendar account associated with the authorized fingerprint. In certain embodiments, determining whether the application is a restricted application includes comparing an application identifier to a security policy.

In certain embodiments, the method includes determining whether the opened application is a restricted application and verifying one or more additional fingerprint captures in response to the application being a restricted application. In such embodiments, the method includes initiating the security response in response to the one or more additional fingerprint captures not matching the authorized fingerprint. For example, the method may include locking the electronic device in response to the one or more additional fingerprint captures not matching the authorized fingerprint.

In one embodiment, verifying one or more additional fingerprint captures includes verifying a fingerprint for each touch of the touchscreen while the restricted application is open. In another embodiment, verifying one or more additional fingerprint captures includes verifying an additional fingerprint at a certain interval while the restricted application is open.

In some embodiments, the method includes accessing a security policy. In such embodiments, comparing the captured fingerprint to the authorized fingerprint occurs in response to a trigger stored in the policy. In some embodiments, the method includes storing the authorized fingerprint in a user profile. In some embodiments, the method includes registering the authorized fingerprint with one or more applications.

Disclosed herein is a program product for unobtrusive electronic device security. In various embodiments, the program product includes a computer readable storage medium that is not a transitory signal and that stores code executable by a processor. Here, the executable code including code to: capture a fingerprint of a user touching a touch surface (e.g., touchscreen) of an electronic device, compare the captured fingerprint to an authorized fingerprint, and initiate a security response in response to the captured fingerprint not matching the authorized fingerprint. The security response may include at least one of: closing an open application, preventing interaction with the application, preventing launch of an unopened application, and locking the electronic device.

In various embodiments, the touch surface comprises one or more of: a touchscreen, a touch panel, a touch-sensitive input device, and a button, wherein the user touches the surface while interacting with the electronic device. In some embodiments, the user touches the touch surface (e.g., touchscreen) at a location for opening an application. In such embodiments, the program product includes code to open the application in response to the captured fingerprint matching the authorized fingerprint. In certain embodiments, the program product includes code to prevent launch of the application in response to the captured fingerprint not matching the authorized fingerprint. Optionally, the program product may also include code to lock the electronic device.

In certain embodiments, the authorized fingerprint is associated with a user. In such embodiments, opening the application in response to the captured fingerprint matching the authorized fingerprint includes accessing, via the application, one or more of: a user account associated with the authorized fingerprint and preferences associated with the authorized fingerprint. For example, opening an email client in response to the captured fingerprint matching the authorized fingerprint may include accessing the email account associated with the authorized fingerprint. In certain embodiments, determining whether the application is a restricted application includes comparing an application identifier to a security policy.

In certain embodiments, the program product includes code to determine whether the opened application is a restricted application, to verify one or more additional fingerprint captures in response to the application being a restricted application, and to initiate the security response in response to the one or more additional fingerprint captures not matching the authorized fingerprint. For example, the program product may include code to lock the electronic device in response to the one or more additional fingerprint captures not matching the authorized fingerprint.

In one embodiment, verifying one or more additional fingerprint captures includes verifying a fingerprint for each touch of the touchscreen while the restricted application is open. In another embodiment, verifying one or more additional fingerprint captures includes verifying an additional fingerprint at a certain interval while the restricted application is open.

In some embodiments, the program product includes code to access a security policy, wherein comparing the captured fingerprint to the authorized fingerprint occurs in response to a trigger stored in the policy. In some embodiments, the program product includes code to store the authorized fingerprint in a user profile. In some embodiments, the program product includes code to register the authorized fingerprint with one or more applications.

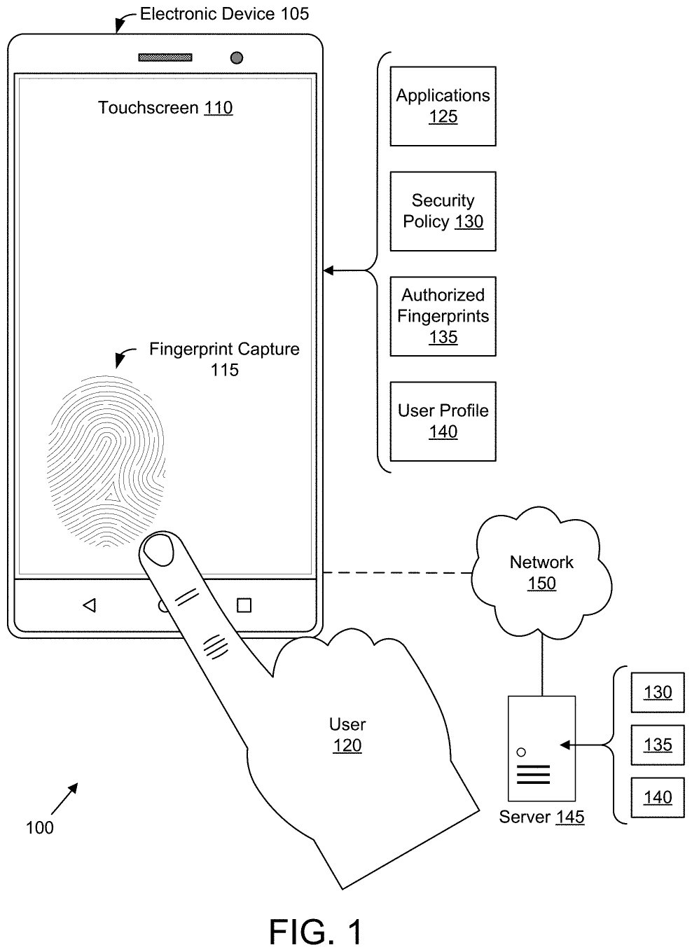

FIG. 1 depicts a system 100 for unobtrusive electronic device security, according to embodiments of the disclosure. The system 100 includes an electronic device 105. In various embodiments, the electronic device 105 includes a touch surface, depicted here as the touchscreen 110, configured to read a fingerprint of the user 120 when the user interacts with the touchscreen 110. For example, one or more fingerprint sensors may be co-located with the touchscreen 110. The electronic device 105 thus acquires one or more fingerprints captures 115 from these user interactions. In other embodiments, the fingerprint captures 115 may be acquired via one or more fingerprint sensors not co-located with the touchscreen 110.

The electronic device 105 includes one or more applications 125 installed thereon. Moreover, the electronic device 105 includes a security policy 130 and a set of one or more authorized fingerprints 135. In various embodiments, the security policy 130 contains one or more rules for when to compare a fingerprint capture 115 to the set of one or more authorized fingerprints 135 and actions to perform in response to unsuccessful authentication of the user 120.

In certain embodiments, the electronic device 105 enters a locked state in response to a fingerprint capture 115 not matching any authorized fingerprints 135. In certain embodiments, the electronic device 105 closes one or more of the applications 125 in response to the fingerprint capture 115 not matching any authorized fingerprints 135. In certain embodiments, the electronic device 105 prevents interaction with one or more of the applications 125 in response to the fingerprint capture 115 not matching any authorized fingerprints 135.

In various embodiments, the fingerprint capture 115 is the result of the user 120 trying to open one of the applications 125. For example, the user 120 may be navigating an application tray, an application drawer, a home screen, a desktop, or other user interface containing applications icons. Here, tapping (a touch based click action) the application icon instructs the electronic device 105 to open (e.g., launch) the application 125 corresponding to the application icon. Accordingly, the electronic device 105 may authenticate the fingerprint capture 115 (e.g., compare the fingerprint capture 115 to the authorized fingerprints 135) and open (e.g., launch) the application 125 if the fingerprint capture 115 is successfully authenticated. However, if the fingerprint capture 115 is unsuccessfully authenticated (i.e., the fingerprint capture 115 does not match any authorized fingerprints 135), then the electronic device 105 initiates one of the security response is discussed above (e.g., enter a lock state).

In some embodiments, the electronic device 105 stores one or more user profiles 140. Each user profile 140 may be associated with an authorized user of the electronic device 105. Moreover, each user profile 140 may be associated with one or more of the authorized fingerprints 135 (e.g., those authorized fingerprints 135 belonging to the authorized user). In some embodiments, an operating system or management application running on the electronic device 105 stores and manages the user profiles 140. In certain embodiments, an application 120 may store and manage its own user profiles 140 independently of the operating system or other applications 120. Note that authenticating the user 125 implicitly identifies the user, thus identifying a user profile 140 of the user 125.

An authorized user may register one or more fingerprints with the electronic device 105, such that the authorized fingerprints 135 comprise the registered fingerprints. In one embodiment, the applications 125 include an authenticator application used to authenticate a user prior to registering the fingerprints. The authenticator application may also allow an authorized user to authenticate herself using credentials other than an authorized fingerprint 135.

Additionally, a user profile 140 may store user preferences, such as settings to automatically apply to an application 125. Here, the electronic device 105 may authenticate a fingerprint capture where the application 125 is launched (opened) and automatically apply user preferences corresponding to that application 125. In certain embodiments, the user profile 140 stores account information for the authorized user. Here, upon launching an application 125, account information is used, for example accessing a user account and associated files belonging to the authorized user.

In some embodiments, the electronic device 105 checks every fingerprint capture 115. In other embodiments, the electronic device 105 checks a fingerprint capture 115 based on the security policy 130. In one example, the security policy 130 instructs the electronic device 105 to check the fingerprint capture 115 when the user 120 wants to open an application. In another example, the security policy 130 instructs the electronic device 105 to check fingerprint captures 115 for each touch of the touchscreen 110. In yet another example, the security policy 130 may instruct the electronic device 105 to check fingerprint captures 115 for each touch corresponding to an interaction with an application having a certain security level or security rating. Thus, applications 125 requiring a high level of security may ensure that the user 120 is authorized to use the application by authenticating the fingerprint capture one on five at a higher rate than those applications 125 not requiring the high level of security.

In some embodiments, the security policy 130 instructs the electronic device 105 to capture fingerprint in response to certain triggering events, such as opening an application, switching applications, expiration of an inactivity timer, etc. In such embodiments, the electronic device 105 may also verify each fingerprint capture 115 acquired in response to a triggering event. Note that with applications 125 requiring a high level of security, the security policy 130 may cause the electronic device 105 to authenticate each touch of the touchscreen 110 or to authenticate a fingerprint capture 115 according to a predetermined interval.

In other embodiments, the security policy 130 instructs the electronic device 105 to capture a fingerprint for every touch of the touchscreen 110. The security policy 130 may instruct the electronic device 105 to authenticate every fingerprint capture 115 or may instruct the electronic device 105 to authenticate a fingerprint capture 115 in response to a triggering event. Where the electronic device 105 does not authenticate each touch of the touchscreen 110, the electronic device 105 may discard or overwrite fingerprint captures 115 that are not to be authenticated. For example, the electronic device 105 may capture a fingerprint for each touch of the touchscreen 110 but may only authenticate a fingerprint capture 115 corresponding to the opening of an application, and interaction with a high security level application, and age restricted application, a user restricted application, or the like.

In various embodiments, the electronic device 105 and may display a notification on the touchscreen 110 in response to the fingerprint capture 115 not matching an authorized fingerprint 135. In one embodiment, a message is displayed informing the user that fingerprint authentication was unsuccessful. Said message may also prompt the user to re-authenticate, for example using another fingerprint capture 115 (e.g., touching the touchscreen 110 again) or using other credentials. One example of such a message includes: “Touch here to continue,” where the user 120 touching the message results in another fingerprint capture 115 for authenticating the user. Another example of such a message includes: “Please enter code to continue,” where the user 120 is prompted to authenticate using other credentials.

In various embodiments, the electronic device 105 does not immediately enter the lock state, prevent interaction with an application, or close the application in response to the fingerprint capture 115 not matching an authorized fingerprint 135. Rather, the electronic device 105 may offer a grace period, that is a limited amount of time in which the user 120 may authenticate herself via subsequent fingerprint capture 115. In certain embodiments, after a threshold number of unsuccessful fingerprint verifications, the electronic device 105 enters the lock state, for example even if the grace period has not ended.

Additionally, the security policy 130 may instruct the electronic device 105 not to authenticate any fingerprint capture 115 when the electronic device 105 is in a certain mode, such as an override mode, guest mode, etc. While in a certain mode, fingerprint captures 115 may be logged but no security response initiated if the fingerprint capture 115 does not match an authorized fingerprint 135.

The electronic device 105 may be any computing device capable of capturing a fingerprint and authenticating a user 120 via a fingerprint capture 115. In some embodiments, the electronic device 105 may be a portable computing device, including, but not limited to, a mobile phone, a smartphone, a tablet computer, a laptop computer, a handheld computer, a wearable computer, a gaming console, or the like. In certain embodiments, the electronic device 105 is an accessory device or a component device capable of capturing a fingerprint and authenticating a user 120 via a fingerprint capture 115. For example, the electronic device 105 may be a mouse, a touchpad, a digital drawing pad, or other device used for interacting with a computer device and having a surface capable of capturing a fingerprint. In such embodiments, the accessory device or component device may not include an embedded display, such as the touchscreen display 110.

In certain embodiments, the system 100 also includes a server 145 accessible via a network 150. The network 150 may include one or more data networks, including, but not limited to, telephone networks, local area networks, wireless networks, the Internet, and the like. In one embodiment, the electronic device 105 may access the server 145 via the network 150 to verify a fingerprint capture 115, store/retrieve the security policy 130, the authorized fingerprints 135, and/or the user profiles 140, or to log activity of the electronic device 105. Here, an electronic device 105 may offload fingerprint authentication by sending a fingerprint capture 115 to the server 145 for verification. Such an electronic device 105 receives a result of the fingerprint authentication and initiates a secure response if the fingerprint capture 115 does not match an authorized fingerprint 135.

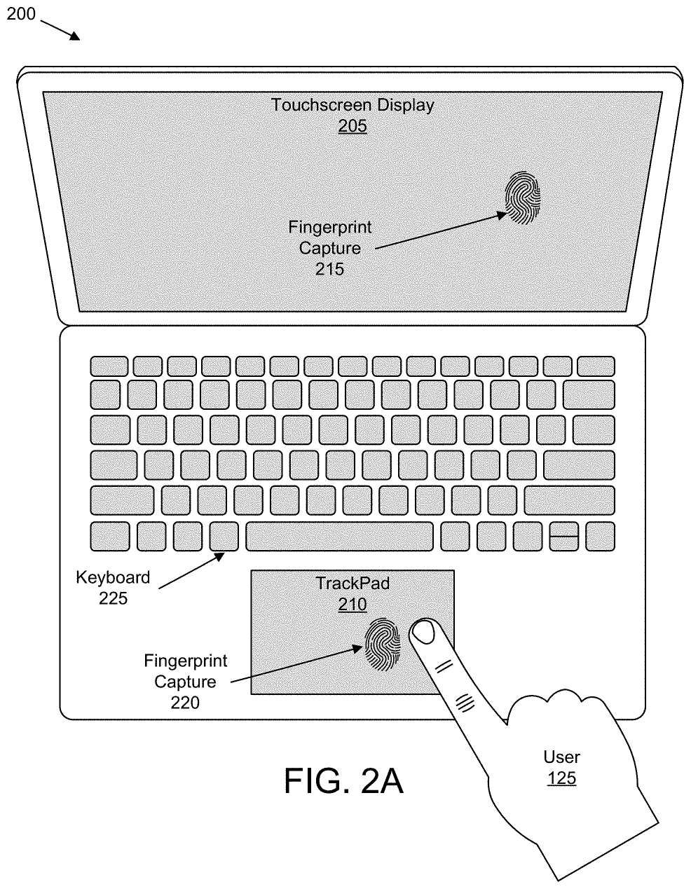

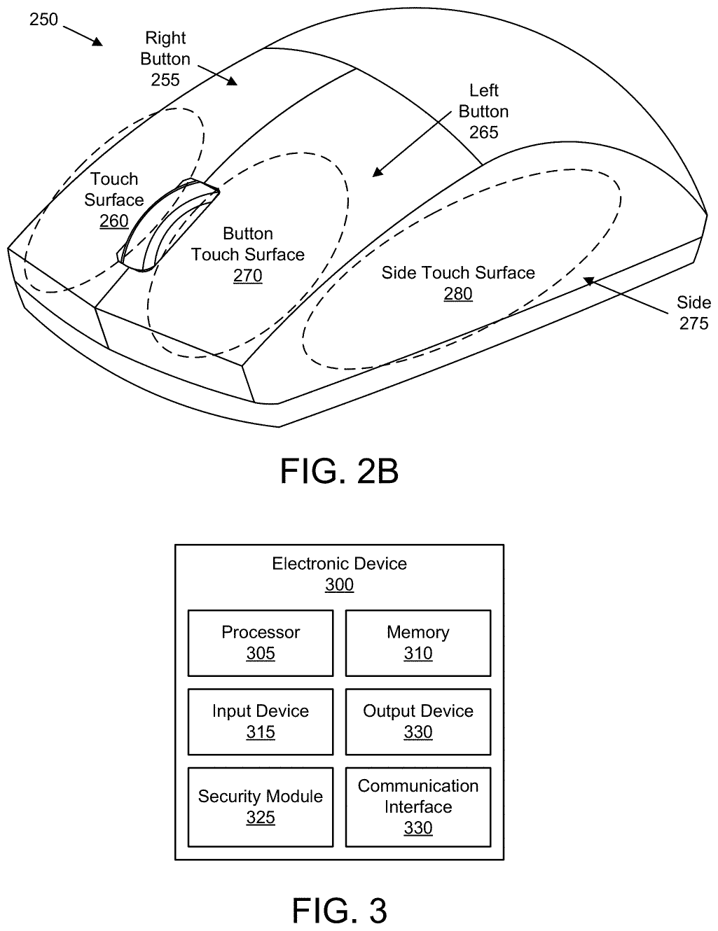

FIG. 2A depicts a computing device 200 for unobtrusive electronic device security, according to embodiments of the disclosure. The computing device 200 may be one embodiment of the electronic device 105. The computing device 200 (depicted here as a laptop computer) has a plurality of touch surfaces, including a touchscreen display 205, which may be one embodiment of the touchscreen 110.

The computing device 200 includes an additional touch surface: the trackpad 210. In various embodiments, both the touchscreen display 205 and the trackpad 210 are configured to capture fingerprints of a user 125 when touched by the user 125. Thus, one fingerprint capture 215 may result from the user 125 touching the touchscreen display 205, while another fingerprint capture 220 may result from the user 125 touching the trackpad 210.

The computing device 200 checks a fingerprint capture 215-220 to identify and/or authenticate the user 125. In one embodiment, the user 125 performs a click-action (e.g., tap) using the touchscreen display 205 in order to open an application. Here, the fingerprint capture 215 may be used to identify/authenticate the user 125 prior to opening the application. In another embodiment, the user 125 performs a click-action (e.g., tap) using the trackpad 210 in order to open an application. Here, the fingerprint capture 220 may be used to identify/authenticate the user 125 prior to opening the application.

FIG. 2B depicts a pointer device 250 for unobtrusive electronic device security, according to embodiments of the disclosure. The pointer device 250 may be one embodiment of the electronic device 105. The pointer device 250 (depicted here as a computer mouse) includes a right button 255, a left button 265, and one or more sides 275. Here, the pointer device 250 has one or more touch surfaces, including one or more of a right button touch surface 260, a left button touch surface 270, and a side touch surface 280. A user fingerprint may be captured by any of the touch surfaces 260, 270, 280.

In one embodiment, the pointer device 250 is an accessory device coupled to an electronic device, such as the computing device 200. In certain embodiments, the pointer device 250 may capture one or more fingerprints and send the fingerprint captures to the electronic device for verification (e.g., user identification/authentication). In various embodiments, if the fingerprint verification is unsuccessful, the pointer device 250 and/or the connected electronic device initiates a security response (e.g., locking the electronic device, disallowing user interaction via the pointer device 250, etc.).

FIG. 3 depicts an electronic device 300 for unobtrusive electronic device security, according to embodiments of the disclosure. The electronic device 300 may be one embodiment of the electronic device 105. The electronic device 300 may include a processor 305, a memory 310, an input device 315, an output device 320, a security module 325, and communication interface 330. In certain embodiments, the electronic device 300 does not contain the communication interface 330. Here, the input device 315 and output device 320 may be an embodiment of the touchscreen 110. In certain embodiments, the electronic device 300 may not have an output device 320.

The electronic device 300 may include a body or an enclosure, with the components of the electronic device 300 being located within the enclosure. In various embodiments, the electronic device 300 includes a battery or power supply that provides electrical power to the electronic device 300. Moreover, the components of the electronic device 300 are communicatively coupled to each other, for example via a computer bus.

The processor 305, in one embodiment, may comprise any known controller capable of executing computer-readable instructions and/or capable of performing logical operations. For example, the processor 305 may be a microcontroller, a microprocessor, a central processing unit (“CPU”), a graphics processing unit (“GPU”), an auxiliary processing unit, a FPGA, or similar programmable controller. In some embodiments, the processor 305 executes instructions stored in the memory 310 to perform the methods and routines described herein. The processor 305 is communicatively coupled to the memory 310, the input device 315, the output device 320, the security module 325, and the communication interface 330.

The memory 310, in one embodiment, is a computer readable storage medium. In some embodiments, the memory 310 includes volatile computer storage media. For example, the memory 310 may include a random-access memory (“RAM”), including dynamic RAM (“DRAM”), synchronous dynamic RAM (“SDRAM”), and/or static RAM (“SRAM”). In some embodiments, the memory 310 includes non-volatile computer storage media. For example, the memory 310 may include a hard disk drive, a flash memory, or any other suitable non-volatile computer storage device. In some embodiments, the memory 310 includes both volatile and non-volatile computer storage media.

In some embodiments, the memory 310 stores data relating to unobtrusive device security. For example, the memory 310 may store a security policy, a set of one or more authorized fingerprints, a set of one or more fingerprint captures, a set of one or more user profiles, and the like. In some embodiments, the memory 310 also stores program code and related data, such as an operating system operating on the electronic device 300 and one or more applications. In one embodiment, the security module 325 may be embodied in a software application (or set of software applications) stored in the memory 310 and operating on the electronic device 300 (e.g., running on the processor 305).

The input device 315, in one embodiment, may comprise any known computer input device including a touch panel, a button, a keyboard, and the like. In some embodiments, the input device 315 (or portion thereof) may be integrated with the output device 320, for example, as a touchscreen or similar touch-sensitive display. In some embodiments, the input device 315 comprises two or more different devices, such as a button and a touch panel. Here, the input device 315 corresponds to the input aspect (e.g., touch panel) of the touchscreen 110.

In various embodiments, the input device 315 comprises one or more sensors for capturing the fingerprint of a user touching the touch surface. In certain embodiments, these sensors may also be used to identify the location on the touch surface that the users touching, identify a number of digits touching the touch surface, etc. so that the user can interact with the electronic device 300 via touch. In some embodiments, the input device 315 includes capacitive sensors for capturing the fingerprint. In some embodiments, the input device 315 includes ultrasonic sensors for capturing the fingerprint. In other embodiments, the input device 315 includes optical sensors and/or thermal sensors for capturing the fingerprint. In other embodiments,

The output device 320, in one embodiment, is configured to output visual, audible, and/or haptic signals. In some embodiments, the output device 320 includes an electronic display capable of outputting visual data to a user. For example, the output device 320 may include an LCD display, an LED display, an OLED display, a projector, or similar display device capable of outputting images, text, or the like to a user. Here, the output device 320 corresponds to the output aspect (e.g., display) of the touchscreen 110. In other embodiments, the output device 320 (and electronic device 300) does not include an electronic display.

In certain embodiments, the output device 320 includes one or more speakers for producing sound, such as an audible alert or notification. In some embodiments, the output device 320 includes one or more haptic devices for producing vibrations, motion, or other haptic output. As mentioned above, all or portions of the output device 320 may be integrated with the input device 315. For example, the input device 315 and output device 320 may form the touchscreen 110.

As another example, the input device 315 and output device 320 may form a touch-sensitive display that includes haptic response mechanisms. In some embodiments, the output device 320 may be located near the input device 315. For example, the microphone, camera, speakers, and touchscreen may all be located on a common surface of the electronic device 300. The output device 320 may receive instructions and/or data for output from the processor 305 and/or the security module 325.

The security module 325, in one embodiment, is configured to capture one or more fingerprints of a user touching the electronic device 300. For example, one or more fingerprints may be captured while the user interacts with a touchscreen. The security module 325 may also compare the captured fingerprint(s) to one or more authorized fingerprints in order to identify and/or authenticate the user. If the captured fingerprint(s) do not match any authorized fingerprint, then the security module 325 may initiate a security response as described herein.

In various embodiments, the security module 325 accesses a security policy to identify when a fingerprint should be verified and what actions to take in response to successful or unsuccessful fingerprint verification, as described herein. In various embodiments, the security module 325 accesses one or more user profiles 140 to retrieve an authorized fingerprint, a user preference, application settings, and the like, as described herein.

The communication interface 330 may include hardware circuits and/or software (e.g., drivers, modem, protocol/network stacks) to support wired or wireless communication between the electronic device 300 and another device or network, such as the network 150. The wireless connection may include a mobile telephone network. The wireless connection may also employ a Wi-Fi network based on any one of the Institute of Electrical and Electronics Engineers (IEEE) 802.11 standards. Alternatively, the wireless connection may be a BLUETOOTH® connection. In addition, the wireless connection may employ a Radio Frequency Identification (RFID) communication including RFID standards established by the International Organization for Standardization (ISO), the International Electrotechnical Commission (IEC), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (IrPHY) as defined by the Infrared Data Association® (IrDA®). Alternatively, the wireless connection may be a cellular telephone network communication. All standards and/or connection types include the latest version and revision of the standard and/or connection type as of the filing date of this application.

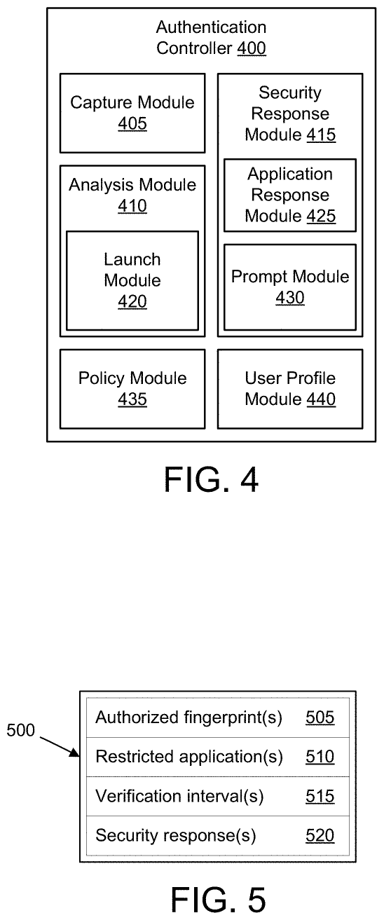

FIG. 4 depicts an authentication controller 400 for unobtrusive electronic device security, according to embodiments of the disclosure. The authentication controller 400 may be one embodiment of the security module 225, discussed above. Further, the authentication controller 400 may be implemented on an electronic device, such as the electronic device 105 and/or electronic device 200. In one embodiment, the controller 400 may be implemented as a hardware circuit comprising custom VLSI circuits or gate arrays, off-the-shelf semiconductors such as logic chips, transistors, or other discrete components. The controller 400 may also be implemented in programmable hardware devices such as field programmable gate arrays, programmable array logic, programmable logic devices or the like.

As depicted, the authentication controller 400 includes a plurality of modules. Specifically, the authentication controller 400 may include a capture module 405, a verification module 410, and a security response module. In certain embodiments, the authentication controller 400 may also include one or more of: a launch module 420, an application requirement module 425, a prompt module 430, a policy module 435 and a user profile module 440. The modules 405-440 may be implemented as hardware, software, or a combination of hardware and software.

The capture module 405, in one embodiment, is configured to capture a fingerprint of a user touching the touch surface. In certain embodiments, the fingerprint is captured via the touch surface. In some embodiments, fingerprints are captured for all touches of the touch surface, even if not all touches are verified. In other embodiments, fingerprints are captured only when certain applications are running or active. In various embodiments, the touch surface comprises one or more of: a touchscreen, a touch panel, a touch-sensitive input device, and a button, wherein the user touches the surface while interacting with the electronic device.

The capture module 405 automatically captures the fingerprint, e.g., in the background, without command or prompt from a user. In certain embodiments, the capture module 405 provides a captured fingerprint to the verification module 410. In certain embodiments, capturing the fingerprint includes storing the fingerprint to a fingerprint capture buffer. Here, the fingerprint capture buffer may store captured fingerprints for a certain amount of time or may store up to a certain number of captures. When user authentication (or identification) is needed, a fingerprint capture may be retrieved from the buffer for analysis. In various embodiments, the capture module 405 maintains the fingerprint capture buffer by deleting and/or overwriting the oldest fingerprints.

The verification module 410, in one embodiment, is configured to compare a captured fingerprint to an authorized fingerprint. As described above, the fingerprint captures may be stored in a buffer, wherein the verification module 410 retrieves a fingerprint capture from the offer and compares it to a set of authorized fingerprints. If the fingerprint capture matches an authorized fingerprint, then the user to whom the fingerprint capture belongs is successfully authenticated. Note that successful fingerprint verification identifies the user. However, if the fingerprint capture does not match any authorized fingerprint, then the user authentication is unsuccessful.

In various embodiments, the verification module 410 may report to the security response module 415 whether a fingerprint capture was successfully or unsuccessfully verified as belonging to an authorized user. As described in further detail below, the security response module 415 may initiate a security response if the fingerprint verification is unsuccessful.

In some embodiments, the verification module 410 compares each captured fingerprint to an authorized fingerprint. For example, the electronic device may be in a security mode or may have a security policy rule requiring fingerprint verification each time the touchscreen is touched. In some embodiments, the verification module 410 compares a captured fingerprint to one or more authorized fingerprints at an interval or timing dictated by a security policy and/or a current security mode.

In other embodiments, the verification module 410 only compares the captured fingerprint to an authorized fingerprint in response to a triggering event. For example, tapping or selecting an application icon (e.g., to open/launch the application) may be a trigger for fingerprint verification. As another example, expiration of a verification timer or inactivity timer may be a trigger for user authentication via fingerprint verification. Other examples of triggering events include, but are not limited to, a user interacting with a restricted application and a user switching to an application. In response to the triggering event, the verification module 410 may retrieve a fingerprint capture from the buffer having a timestamp that corresponds to the triggering event. In various embodiments, these triggering events are indicated by a security policy stored at the electronic device.

In various embodiments, one or more authorized fingerprints are registered with the verification module 410. For example, during a fingerprint registration state a user may touch one or more fingers to the touchscreen, wherein the capture module 405 captures fingerprints corresponding to the touches and registers the captured fingerprints with the verification module 410 as authorized fingerprints. Another example, a set of digital fingerprints may be retrieved by the verification module 410, wherein the retrieved set of digital fingerprints are registered as authorized fingerprints. Here, the digital fingerprints correspond to an authorized user of the electronic device.

The security response module 415, in one embodiment, is configured to initiate a security response if the captured fingerprint does not match an authorized fingerprint. Examples of security responses include, but are not limited to, locking the electronic device, “freezing” an application to prevent user interaction with the application, closing an application, preventing an application from opening or launching, prompting the user for security credentials, and the like. In various embodiments, the security response module 415 stores a log indicating when a security response was initiated and, if at workable, a type of security response initiated.

In certain embodiments, initiating the security response includes initiating a lockout timer. Recognizing that sometimes the touch of an authorized user to the touchscreen may result in a partial fingerprint, such that it does not match the set of authorized fingerprints, or that the touch does not result in a legible fingerprint, the security response module 415 may offer a “grace period” after a user touch results in a fingerprint capture that does not match an authorized fingerprint. The length of the grace period is measured by the lockout timer. During the grace period (e.g., while the lockout timer is active) the security response module 415 may cause the verification module 410 to authenticate each touch of the touchscreen. If a fingerprint matching authorized print is not received prior to expiration of the lockout timer, then the security response module 415 locks the electronic device and/or implement other measures to secure the device from an unauthorized user. However, if the verification module 410 reports successful authentication of a fingerprint capture during the grace period, then the lockout timer is canceled, and normal activity resumed.

In certain embodiments, an authorized user may cause the security response module to enter an override mode. Here, normal security measures are overridden such that fingerprint captures that do not match any authorized fingerprint do not initiate any security measures. As such, the override mode may allow a guest to use electronic device. In various embodiments, the capture module 405, verification module 410, and/or security response module 415 may enter an inactive state while the override mode is active.

In the depicted embodiment, the security response module 415 may include an application requirement module 425 for determining security requirements for an application installed on the electronic device and/or a prompt module 430 for displaying one or more props to the user. These modules are discussed in greater detail below.

The launch module 420, in one embodiment, is configured to launch application in response to successful verification of a fingerprint capture. In various embodiments, the fingerprint capture is verified when the touch resulting in the fingerprint capture corresponds to a tap (e.g., click action) or selection of an application icon. Here, the tap or selection is intended to open and/or launch an application corresponding to the application icon. Upon successful verification of the fingerprint capture, the launch module 420 will open and/or launch the corresponding application. However, upon unsuccessful verification of the fingerprint capture, the launch module 420 may prevent the opening or launching of the corresponding application.

In certain embodiments, the launch module 420 modifies the behavior of the application based on which user is opening the application. For example, when an email client is opened, the launch module 420 may cause the email client access and email account associated with the authorized user touching the touch surface. As another example, when a calendar application is opened, the launch module 420 may access calendar data specific to the authorized user touching the touch surface. In a third example, when a photo of your application is opened, the launch module 420 may access a photo album belonging to the authorized user touching the touch surface.

In certain embodiments, the launch module 420 identifies preferences associated with the authorized fingerprint and modifies the behavior of the application based on the identified preferences. In one embodiment, the identified preferences indicate a thematic element for the application. In another embodiment, the identified preferences indicate background behavior and/or default behaviors to be performed by the application. For example, the identified preferences may indicate default file locations default file types, and the like.

The application requirement module 425, in one embodiment, is configured to identify a security requirement of an application install on the electronic device. The application requirement module 425 may provide the security requirements to the verification module 410, wherein the verification module 410 authenticates fingerprint captures at a frequency indicated by the security requirements. The application requirement module 425 may provide the security requirements to the security response module 415, wherein the security response module 415 selects a security response based on the security requirements.

Note that the security requirements may be on a per-application basis. Accordingly, applications requiring a higher level security may trigger increased frequency of fingerprint verification and/or stricter security responses (e.g., closing the application, locking the device), while applications requiring a lower level of security may trigger decreased frequency of fingerprint verification (e.g., checks only on startup or never checked) and/or more lenient security responses (e.g., preventing interaction with the application, initiating a grace period, etc.).

In various embodiments, the electronic device may have installed thereon one or more applications requiring a high level of security. In various embodiments, the electronic device may have installed thereon one or more applications having an age restriction. In various embodiments, the electronic device may have installed thereon one or more applications restricted to specific users. These applications having special security requirements may be referred to as “restricted applications.”

Examples of restricted applications include, but are not limited to, banking applications, mobile payment applications, password management applications, and the like. Here, the application requirement module 425 may identify one or more restricted applications installed on the electronic device. In one embodiment, determining whether an application is a restricted application includes comparing an application identifier to a security policy.

The prompt module 430, in one embodiment, is configured to prompt for user authentication if a fingerprint capture does not match any authorized fingerprint. In certain embodiments, the prompt module 430 may display notification in response to the security response module 415 initiating a security response. For example, the notification may indicate that an application cannot be launched due to the authentication controller 400 not recognizing the fingerprint. As another example, the notification may indicate that the electronic device is locked due to the fingerprint not matching any authorized fingerprint.

In various embodiments, the prompt module 430 may prompt the user to authenticate using other credentials in response to initiating the security response. Examples of other credentials include a username and password, facial recognition, voice recognition, passphrase, and the like. In various embodiments, the security response may be canceled in response to successful user authentication using the other credentials.

The policy module 435, in one embodiment, is configured to access a security policy. In various embodiments, the security policy indicates when a captured fingerprint is to be authenticated (e.g., the security policy may define one or more trigger events). The security policy may indicate what applications are to be considered restricted applications. The security may indicate a default security response.

The user profile module 440, in one embodiment, is configured to access and/or maintain a user profile corresponding to an authorized user. In various embodiments, the user profile may store fingerprints of the authorized user (referred to as “authorized fingerprints”). In some embodiments, the user profile may also store user preferences, for example, indicating settings and/or behaviors to be implemented upon launching an application. In some embodiments, the user profile may store one or more account names and/or account credentials, e.g., to be used in conjunction with application stored on the electronic device.

FIG. 5 depicts a data structure 500 for unobtrusive electronic device security, according to embodiments of the disclosure. In various embodiments, the data structure 500 may be one embodiment of the security policy 130 discussed above. The data structure 500 may be created by an electronic device, such as the electronic device 105, the computing device 200, the pointer device 250, the electronic device 300, by the security module 325, and/or by the authentication controller 400.

As depicted, the data structure 500 includes various activity entries relating to unobtrusive electronic device security, which (e.g., collectively) may indicate a security policy for the electronic device. The data structure 500 stores one or more authorized fingerprints 505 which correspond authorized users of the electronic device. The data structure 500 stores one or more restricted applications 510. As mentioned above, a restricted application 510 is one requiring a higher level of security. In certain embodiments, a restricted application 510 is an application requiring user authentication/identification before opening.

The data structure 500 may include one or more verification intervals 515. Here, the verification interval 515 indicates when a fingerprint capture is to be compared to the one or more authorized fingerprints 505. The data structure 500 also includes one or more security responses 520. Here, the security responses 520 indicate actions the electronic device is to perform in response to unsuccessful fingerprint verification.

In certain embodiments, one or more of the items 505-420 are embodied in one or more security policy rules. Here, the security policy rules may indicate a condition to be met, and an action to perform if the condition is met. One example of a security policy rule is to authenticate a user via fingerprint recognition whenever the user touches (or clicks on) an icon in the application drawer. Another example of a security policy rule is to authenticate each touch (e.g., interaction) whenever a sensitive (restricted) application is open, for example a mobile banking application, mobile payment application, password management application, etc. Note that a security policy rule may apply to all applications on the electronic device or only certain ones of the applications on the electronic device.

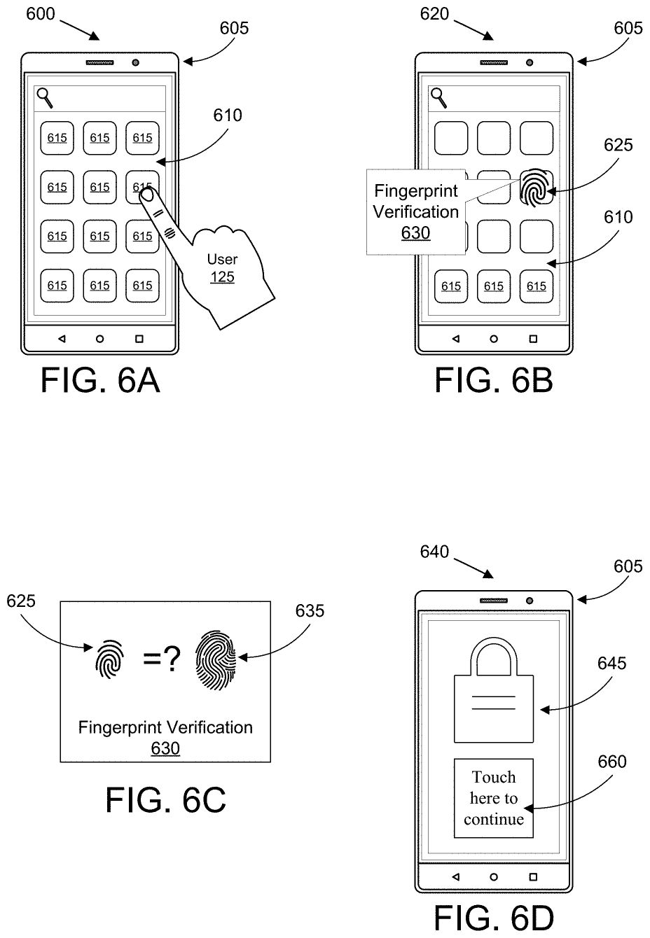

FIGS. 6A-6D depict a first scenario of unobtrusive device security, according to embodiments of the disclosure. The first scenario involves a handheld device 605, which may be an embodiment of the electronic device 105 and/or the electronic device 200. In various embodiments, the handheld device 605 includes a security module 225 and/or an authentication controller 300. The handheld device 605 includes a touch surface (e.g., touchscreen) configured to capture the fingerprint of a user 120 touching the touch surface.

FIG. 6A depicts a first moment 600 of the first scenario. Here, the handheld device 605 displays an application drawer 610. The application drawer 610 includes a plurality of application icons 615. The user 120 taps on an application icon 615 corresponding to a desired application. The act of touching the touch surface allows the handheld device 605 to capture a fingerprint 625 of the user 120.

FIG. 6B depicts a second moment 620 of the first scenario. Here, the user 120 has tapped on an application icon 615 and the handheld device 605 has captured a fingerprint 625 of the user. The handheld device 605 performs fingerprint verification 630 death indicate the user 120 using the captured fingerprint 625.

FIG. 6C depicts the fingerprint verification 630. Here, the captured fingerprint 625 is compared to one or more authorized fingerprints 635. If the captured fingerprint 630 matches one of the authorized fingerprints 635, then the fingerprint verification 630 is successful and the user 120 is authenticated. However, if the captured fingerprint 625 does not match any of the authorized fingerprints 635, then the fingerprint verification 630 is unsuccessful.

In the depicted embodiment, the captured fingerprint 625 does not match any authorized fingerprint 635, thus the handheld device 605 implements one or more security responses. However, if the captured fingerprint 630 matches an authorized fingerprint 635, then the handheld device 605 may launch the application corresponding to the touched application icon 615. As discussed above, the handheld device 605 may automatically apply one or more user settings/preferences corresponding to the authorized fingerprint 635.

FIG. 6D depicts a security response 640 implemented during the first scenario. In the depicted example, the handheld device 605 enters a lock state 645 in response to unsuccessful fingerprint verification 630. In some embodiments, while in the lock state 645 the handheld device 605 displays a message 650. As depicted, the message 650 invites the user 120 to touch the screen, which will result in a new fingerprint capture. If the new fingerprint capture matches an authorized fingerprint 635, then the security response 640 ends and the handheld device 605 exits the lock state 645.

In other embodiments, a different and/or additional security response is initiated by the handheld device 605. As discussed above, the handheld device 605 may ignore a user touch corresponding to unsuccessful fingerprint verification 630, thereby preventing the user 120 from interacting with an application.

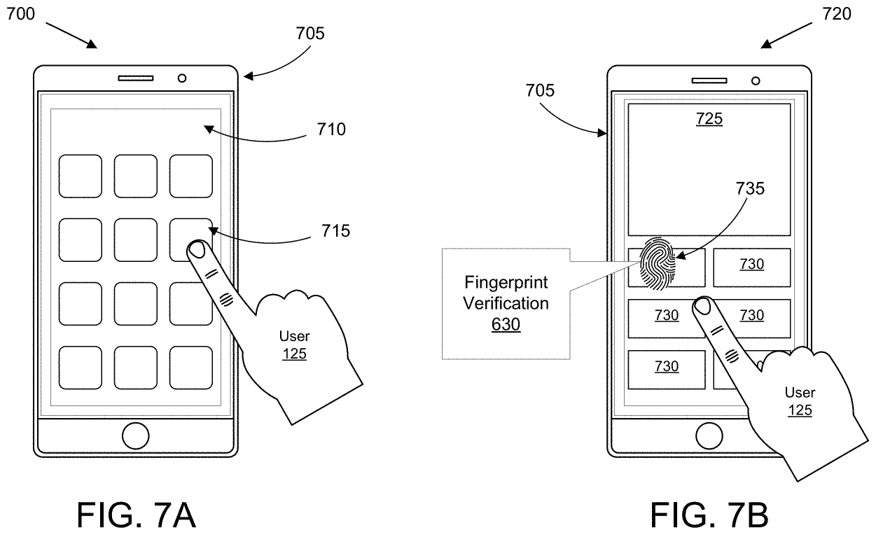

FIGS. 7A-7B depict a second scenario of unobtrusive device security, according to embodiments of the disclosure. The second scenario involves a handheld device 705, which may be an embodiment of the electronic device 105 and/or the electronic device 200. In various embodiments, the handheld device 705 includes a security module 225 and/or an authentication controller 300. The handheld device 705 includes a touch surface (e.g., touchscreen) capable of capturing the fingerprint of a user 120 touching the surface.

FIG. 7A depicts a first moment 700 of the second scenario. Here, the handheld device 705 displays a home screen 710 having a plurality of application icons. The user 120 taps on an application icon 715 corresponding to a desired application. The act of touching the touch surface allows the handheld device 705 to capture a fingerprint of the user 120. In some embodiments, the handheld device 705 may verify the fingerprint capture prior to opening the desired application.

FIG. 7B depicts a second moment 720 of the first scenario. Here, the handheld device 705 is running an application 725 corresponding to the application icon 715. In the depicted scenario, the application 725 requires a higher level security the normal applications. Accordingly, the handheld device 705 performs one or more additional fingerprint captures what the user 120 is interacting with the application 725 in order to continuously authenticate the user 120. As discussed above, applications requiring a higher level security include, but are not limited to, baking applications, mobile payment applications, password manager applications, and the like.

During the second moment 720, the user 120 has tapped on a control icon 730 of the application 725, resulting in an additional fingerprint capture 735. The handheld device 705 performs fingerprint verification 630 on the additional fingerprint capture 735. As discussed above, if the fingerprint verification of the additional fingerprint capture 735 is successful, then the user 120 is permitted to continue interacting with the application 725. However, if the fingerprint verification 630 of the additional fingerprint capture 735 is unsuccessful, then the handheld device 705 initiates a security response, such as entering a lock state, closing the application 725, and/or preventing user interaction with the application 725.

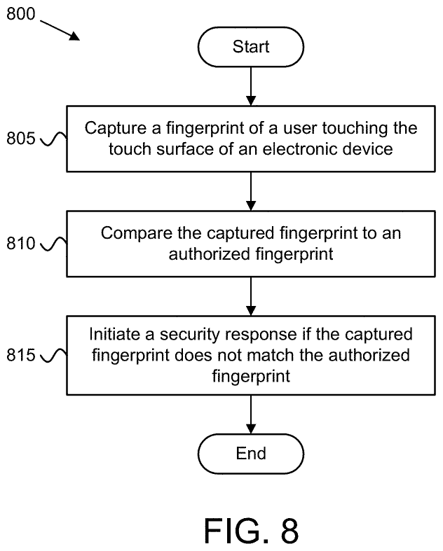

FIG. 8 depicts a method 800 for unobtrusive electronic device security, according to embodiments of the disclosure. In some embodiments, the method 800 is performed by electronic device 105, the computing device 200, the pointer device 250, the electronic device 300, the security module 325, and/or the authentication controller 400, described above. In some embodiments, the method 800 is performed by a processor, such as a microcontroller, a microprocessor, a CPU, a GPU, an auxiliary processing unit, a FPGA, or the like.

The method 800 begins and captures 805 a fingerprint of a user touching a touch surface on an electronic device. In certain embodiments, the touch surface is a touchscreen and the fingerprint is captured 805 via one or more sensors co-located with the touchscreen. The method 800 includes comparing 810 the captured fingerprint to an authorized fingerprint. In certain embodiments, comparing 810 the captured fingerprint to the authorized fingerprint occurs in response to a trigger stored in the security policy.

The method 800 includes initiating 815 a security response in response to the captured fingerprint not matching the authorized fingerprint. In various embodiments, initiating 815 the security response comprises at least one of: closing an open application, preventing interaction with the application, preventing launch of an unopened application, and locking the electronic device. The method 800 ends.

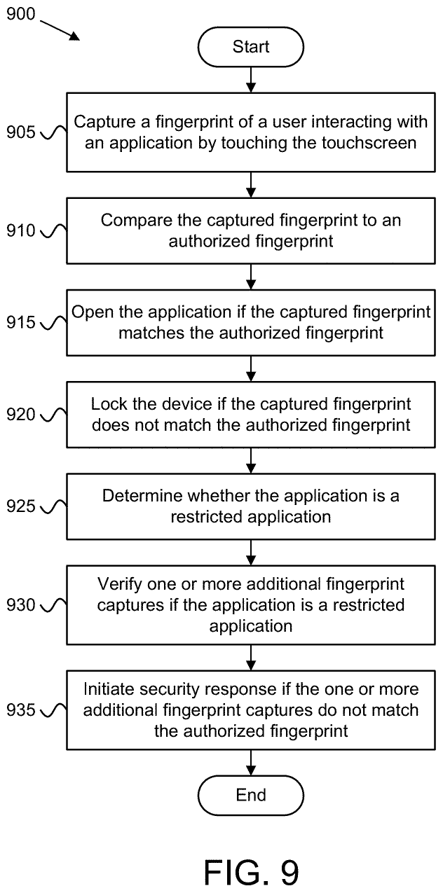

FIG. 9 depicts a method 900 for unobtrusive electronic device security, according to embodiments of the disclosure. In some embodiments, the method 900 is performed by the electronic device 105, the computing device 200, the pointer device 250, the electronic device 300, the security module 325, and/or the authentication controller 400, described above. In some embodiments, the method 900 is performed by a processor, such as a microcontroller, a microprocessor, a CPU, a GPU, an auxiliary processing unit, a FPGA, or the like.

The method 900 begins and capture 905 a fingerprint of a user interacting with an application by touching the touchscreen on an electronic device. In some embodiments, the fingerprint is captured 905 via one or more sensors co-located with the touchscreen.

The method 900 includes comparing 910 the captured fingerprint to an authorized fingerprint. In certain embodiments, comparing 910 the captured fingerprint to the authorized fingerprint occurs in response to a trigger stored in the security policy

The method 900 includes opening 915 the application in response to the captured fingerprint matching the authorized fingerprint. The method 900 includes locking 920 the electronic device in response to the captured fingerprint not matching the authorized fingerprint.

The method 900 includes determining 925 whether the application is a restricted application. In certain embodiments, determining 925 whether the application is a restricted application comprises comparing an application identifier to a security policy

The method 900 includes verifying 930 one or more additional fingerprint captures in response to the application being a restricted application. In one embodiment, verifying 930 one or more additional fingerprint captures comprises verifying a fingerprint for each touch of the touchscreen while the restricted application is open. In another embodiment, verifying 930 one or more additional fingerprint captures comprises verifying an additional fingerprint at a certain interval while the restricted application is open.

The method 900 includes initiating 935 a security response in response to the one or more additional fingerprint captures not matching the authorized fingerprint, the security response comprising at least one of: closing the application, preventing interaction with the application, and locking the electronic device. The method 900 ends.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a touch surface;
a processor; and
a memory that stores code executable by the processor to:
capture a fingerprint of a user touching the touch surface;
compare the captured fingerprint to an authorized fingerprint; and
initiate a security response in response to the captured fingerprint not matching the authorized fingerprint.

2. The apparatus of claim 1, wherein initiating the security response comprises at least one of: closing an open application, preventing interaction with the application, preventing launch of an unopened application, and locking the apparatus.

3. The apparatus of claim 1, wherein the touch surface comprises one or more of: a touchscreen, a touch panel, a touch-sensitive input device, and a button, wherein the user touches the surface while interacting with the apparatus.

4. The apparatus of claim 1, wherein the touch surface is a touchscreen and the user touches the touchscreen at a location for opening an application, wherein the processor opens the application in response to the captured fingerprint matching the authorized fingerprint.

5. The apparatus of claim 4, wherein the authorized fingerprint is associated with a user, wherein opening the application in response to the captured fingerprint matching the authorized fingerprint comprises accessing, via the application, one or more of: a user account associated with the authorized fingerprint and preferences associated with the authorized fingerprint.

6. The apparatus of claim 4, wherein the processor further:
determines whether the application is a restricted application;
verifies one or more additional fingerprint captures in response to the application being a restricted application; and
initiates the security response in response to the one or more additional fingerprint captures not matching the authorized fingerprint.

7. The apparatus of claim 6, wherein verifying one or more additional fingerprint captures comprises verifying a fingerprint for each touch of the touchscreen while the restricted application is open.

8. The apparatus of claim 6, wherein verifying one or more additional fingerprint captures comprises verifying an additional fingerprint at a certain interval while the restricted application is open.

9. The apparatus of claim 1, wherein the processor accesses a security policy, wherein comparing the captured fingerprint to the authorized fingerprint occurs in response to a trigger stored in the policy.

10. The apparatus of claim 1, wherein the processor stores the authorized fingerprint in a user profile and registers the authorized fingerprint with one or more applications.

11. A method comprising:
capturing a fingerprint of a user touching a touch surface of an electronic device;
comparing, by use of a processor, the captured fingerprint to an authorized fingerprint; and
initiating a security response in response to the captured fingerprint not matching the authorized fingerprint.

12. The method of claim 11, wherein initiating the security response comprises at least one of: closing an open application, preventing interaction with the application, preventing launch of an unopened application, and locking the electronic device.

13. The method of claim 11, wherein the touch surface comprises one or more of: a touchscreen, a touch panel, a touch-sensitive input device, and a button, wherein the user touches the touch surface while interacting with the electronic device.

14. The method of claim 11, wherein the touch surface is a touchscreen and the user touches the touchscreen at a location for opening an application, the method further comprising opening the application in response to the captured fingerprint matching the authorized fingerprint.

15. The method of claim 14, further comprising:
determining whether the application is a restricted application;
verifying one or more additional fingerprint captures in response to the application being a restricted application; and
locking the electronic device in response to the one or more additional fingerprint captures not matching the authorized fingerprint.

16. The method of claim 15, wherein verifying one or more additional fingerprint captures comprises one of: verifying a fingerprint for each touch of the touchscreen while the restricted application is open.

17. The method of claim 11, further comprising accessing a security policy, wherein comparing the captured fingerprint to the authorized fingerprint occurs in response to a trigger stored in the security policy.

18. The method of claim 11, further comprising:
storing the authorized fingerprint in a user profile; and
registering the authorized fingerprint with one or more applications installed on the electronic device.

19. A program product comprising a computer readable storage medium that stores code executable by a processor, the executable code comprising code to:
capture a fingerprint of a user touching a touchscreen of an electronic device;
compare the captured fingerprint to an authorized fingerprint; and
initiate a security response in response to the captured fingerprint not matching the authorized fingerprint, wherein the security response comprises at least one of: closing an open application, preventing interaction with the application, preventing launch of an unopened application, and locking the electronic device.

20. The program product of claim 19, wherein the user touches the touchscreen at a location for opening an application, wherein the program product further comprises code to open the application in response to the captured fingerprint matching the authorized fingerprint.
